(19) United States
(12) Patent Application Publication
(10) Pub. No.: US 2007/0083615 A1
(43) Pub. Date: Apr. 12, 2007

(54) Cross-enterprise wallplug for connecting internal hospital/clinic imaging systems to external storage and retrieval systems

(76) Inventors: Robert J. Hollebeek, BERWYN, PA (PA); Mitchell D. Schnall, Wayne, PA (US); Barbara G. Beckerman, Knoxville, TN (US); Patricia W. Payne, Knoxville, TN (US); Frank Paul Hammitt, Knoxville, TN (US)

Correspondence Address: RATNERPRESTIA, P O BOX 980, VALLEY FORGE, PA, 19482-0980, US

(21) Appl. No.: 10/558,989

(22) PCT Filed: Jun. 4, 2004
(86) PCT No.: PCT/US04/18010

§ 371 Date: May 4, 2006

Related U.S. Application Data
(60) Provisional application No. 60/476,116, filed on Jun. 4, 2003.

(51) Int. Cl. G06F 15/16

(52) U.S. Cl. 709/218

(57) ABSTRACT

A WallPlug (interface) connects DICOM devices located at a hospital to external storage and retrieval systems. The external storage and retrieval systems can be part of the National Digital Mammography Archive. The WallPlug allows secure communications within the hospital setting, and allows only selected data to be transferred between the hospital devices and the archive. The WallPlug enables cross-enterprise distribution of medical content with proper authentication and logging of transfers. The WallPlug includes two portals connected together by a private secure network. The use of two separate devices greatly enhances the security, redundancy, and manageability of the combined device.

### CROSS REFERENCE TO RELATED APPLICATIONS

The present application claims priority to U.S. Provisional Application No. 60/476,116, filed Jun. 4, 2003, entitled “NDMA WALLPLUG FOR CONNECTING HOSPITAL DICOM DEVICES TO EXTERNAL STORAGE AND RETRIEVAL,” which is hereby incorporated by reference in its entirety. The subject matter disclosed herein is related to the subject matter disclosed in U.S. patent application Ser. No. ------ (Attorney Docket UPN-4381/P3180), filed on even date herewith and entitled “NDMA SOCKET TRANSPORT PROTOCOL”, the disclosure of which is hereby incorporated by reference in its entirety. The subject matter disclosed herein is also related to the subject matter disclosed in U.S. patent application Ser. No. ------- Attorney Docket UPN-4382/P3189), filed on even date herewith and entitled “NDMA SCALABLE ARCHIVE HARDWARE/SOFTWARE ARCHITECTURE FOR LOAD BALANCING, INDEPENDENT PROCESSING, AND QUERYING OF RECORDS”, the disclosure of which is hereby incorporated by reference in its entirety. The subject matter disclosed herein is further related to the subject matter disclosed in U.S. patent application Ser. No. ------- (Attorney Docket UPN-4383/P3190), filed on even date herewith and entitled “NDMA DATABASE SCHEMA, DICOM TO RELATIONAL SCHEMA TRANSLATION, AND XML TO SQL QUERY TRANSLATION”, the disclosure of which is hereby incorporated by reference in its entirety.

### FIELD OF THE INVENTION

The present invention generally relates to an interface between medical imaging facilities and external services and, more particularly, to an interface between DICOM or HL7 compatible imaging systems and NDMA compatible storage systems.

### BACKGROUND

Prior systems for storing digital mammography data included making film copies of the digital data, storing the copies, and destroying the original data. Distribution of information basically amounted to providing copies of the copied x-rays. This approach was often chosen due to the difficulty of storing and transmitting the digital data itself. The introduction of digital medical image sources and the use of computers in processing these images after their acquisition has led to attempts to create a standard method for the transmission of medical images and their associated information. The established standard is known as the Digital Imaging and Communications in Medicine (DICOM) standard. Compliance with the DICOM standard is crucial for medical devices requiring multi-vendor support for connections with other hospital or clinic resident devices.

The DICOM standard describes protocols for permitting the transfer of medical images in a multi-vendor environment, and for facilitating the development and expansion of picture archiving and communication systems and interfacing with medical information systems. It is anticipated that many (if not all) major diagnostic medical imaging vendors will incorporate the DICOM standard into their product design. It is also anticipated that DICOM will be used by virtually every medical profession that utilizes images within the healthcare industry. Examples include cardiology, dentistry, endoscopy, mammography, ophthalmology, orthopedics, pathology, pediatrics, radiation therapy, radiology, surgery, and veterinary medical imaging applications. It is anticipated that utilization of the DICOM standard will facilitate communication and archiving of records from these areas in addition to mammography. Thus, a general method for interfacing between instruments inside the hospital and external services acquired through networks and of providing services as well as information transfer is desired. It is also desired that such a method enable secure cross-enterprise access to records with proper tracking of records access in order to support a mobile population acquiring medical care at various times from different providers.

In order for imaging data to be available to a large number of users, an archive is appropriate. The National Digital Mammography Archive (NDMA) is such an archive designed for storing digital mammography data. The NDMA acts as a dynamic resource for images, reports, and all other relevant information tied to the health and medical record of patients. Also, the NDMA is a repository for current and previous year studies and can provide services and applications for both clinical and research use. The NDMA may very well revolutionize breast cancer screening programs in North America. Because of the concern of patients' privacy, the NDMA ensures the privacy and confidentiality in compliance with all relevant federal regulations.

To facilitate distribution of imaging data, one could attempt to couple DICOM and Grid compatible systems to archival systems such as NDMA compatible systems. Grid compatible systems use Open Grid Standards for system authentication and for locating and using services, and NDMA compatible systems use NDMA protocols for authentication and acquiring services. Open standards are publicly available specifications for enhancing compatibility between various hardware and software components. However, to effectively achieve this coupling, many obstacles must be overcome. For example, to reach a large number of users, the Internet would seem appropriate; however, the Internet is not designed to handle the protocols utilized in DICOM. Further, NDMA supports DICOM formats for records and certain DICOM interactions within the hospital, but NDMA uses its own protocols and procedures for efficient and secure file transfer and manipulation. Also, as described above, patients' privacy must be maintained and appropriate isolation (e.g., firewall protection) between the hospital side and the storage side should be provided. As will be explained below, NDMA protocols together with the WallPlug hardware and software of the invention together make it possible to interface DICOM and GRID compatible systems to NDMA.

One attempt to communicate storage and retrieval transactions between a system for querying, storing, retrieving, and delivering digital data and images and participating institutions is described in U.S. Pat. No. 6,574,742, issued to Jamroga et al. (Jamroga et al.). In Jamroga et al., a central database provides long term storage of medical image data, including DICOM image data. The central database is connected to a plurality of remote participant institutions, such as hospitals, healthcare facilities or medical imaging centers. The institutional user has the ability to query his local server and to query the database if the requested information is not stored locally. Jamroga et al. also describes using encryption/decryption techniques for transmitting data between the institutional server and the database via a proxy server. However, Jamroga et al. does not specifically address the NDMA. Further, the proxy server arrangement described in Jamroga et al. does not provide the isolation needed in many scenarios requiring a high degree of privacy/security.

Many attributes of a system for distributing information between hospitals/clinics and storage devices/services are desired. One desired attribute is efficient data transfer on networks on both sides (e.g., hospital side and storage side) of the system. Another is maintenance of the integrity of the hospital side network security and incorporation of strong firewall-like protection. Yet another is ensuring privacy of medical records being transferred (e.g., utilizing encryption and decryption). The provision and maintenance of security of administrative functions performed on the hospital side is also desired. Remote operation of portions of the systems is another desired attribute. Self test and remote management and control are also desired attributes.

Thus, a need exists for a mechanism having the above attributes that couples internal hospital/clinic medical systems to external storage and retrieval devices, and/or services and that provides privacy protection, provides security, does not hamper operations on the hospital (e.g., DICOM) side, provides encryption on the storage (e.g., external network) side, provides strong authentication, and remote management, that can efficiently transfer large amounts of data between the hospital/clinic medical systems and the NDMA or other services and collections, and that can be externally controlled and monitored.

### SUMMARY OF THE INVENTION

A WallPlug (interface) comprising two portal systems (portals) connects systems located at institutions such as a hospitals or clinics to external storage and retrieval systems. As construed herein a portal comprises a combination of hardware, software, network connections, and security capabilities for transferring information therein. One portal is coupled to the systems at the institution (hereinafter referred to as the hospital) and the other portal is coupled to the external storage and retrieval systems (hereinafter referred to as external). Each portal is fully compatible with the system to which it is connected, and in one embodiment, the two portals operate under different operating systems (e.g., WINDOWS® 2000 and LINUX®). The portals are coupled to each other via a private secure network. The WallPlug is part of the external system and represents the local footprint for services provided by the external system (e.g., archival and retrieval services) at the hospital location. Thus, the WallPlug is a virtual storage/retrieval instrument inside the hospital or clinic. The hospital systems can comprise DICOM compatible or Health Level 7 (HL7) compatible systems and the external side (archive side) systems can comprise NDMA compatible systems. HL7 is a vendor independent standard for communicating patient scheduling, billing, and medical history information. The WallPlug allows secure communications within the hospital setting, and allows only selected data to be transferred between the hospital devices and the archive. The WallPlug enables cross-enterprise distribution of medical content with proper authentication and logging of transfers. Cross-enterprise interactions are those which allow unassociated entities to exchange information, content, and services.

The present invention also includes a method for transferring data between a digital imaging and communications in medicine (DICOM) compatible device and a storage device, the method comprising the steps of: receiving DICOM related data; storing the received DICOM related data in a data queue managed by a DICOM server; transferring the data queue to a work list; verifying the DICOM related data; formatting the DICOM related data into a format compatible with the storage device; and transmitting the DICOM related data via a virtual private network (VPN) to the storage device.

Services provided to the hospital via the WallPlug include many new uses of information at the hospital such as collection of research cases, annotated teaching cases, digital computer assisted diagnosis, rapid retrieval of previous clinical records for use in diagnosis, access to large scale storage or processing capabilities, and cross-enterprise exchange of digital medical records. Other features and services of the invention will be apparent from the following detailed description.

### BRIEF DESCRIPTION OF THE DRAWINGS

FIG. 1 is a block diagram of firewalled hospital systems coupled to a WallPlug via a TCPIP compatible network, and an archive coupled to the WallPlug via a virtual private network in accordance with an exemplary embodiment of the present invention;

FIG. 2 is a block diagram showing the WallPlug of the invention comprising a first portal coupled to the DICOM compatible network, a second portal coupled to the virtual private network, and the two portals coupled together via a private secure network in accordance with an exemplary embodiment of the present invention;

FIG. 3 is a block diagram of software components utilized to transfer data between the hospital systems and the archive in accordance with an exemplary embodiment of the present invention;

FIG. 4A is a more detailed block diagram of the WallPlug showing software and hardware components utilized for transferring test records and patient records in accordance with an exemplary embodiment of the present invention;

FIG. 4B is a more detailed block diagram of the WallPlug showing software and hardware components utilized for administrative functions in accordance with an exemplary embodiment of the present invention;

FIG. 5 is a block diagram of software components in the National Digital Mammography Archive (NDMA) utilized to transfer data to and from the WallPlug in accordance with an exemplary embodiment of the present invention; and

FIG. 6 is a block diagram of the NDMA system in accordance with an exemplary embodiment of the present invention.

### DESCRIPTION OF EMBODIMENTS OF THE INVENTION

A WallPlug in accordance with the present invention provides an apparatus and method for interfacing between instruments inside the hospital and external services acquired through networks and of providing services as well as information transfer. The WallPlug enables secure cross-enterprise access to records with proper tracking of records access in order to support a mobile population acquiring medical care at various times from different providers, thus forming a starting basis for cross-enterprise exchange of digital patient records.

The WallPlug provides efficient data transfer on networks on both sides (e.g., hospital side and storage side) of the system by providing scheduling control and optimization of network interfaces for large volume transfers. This is provided on both the hospital/clinic side and the wide area network side.

In one embodiment, DICOM interactions with medical devices within the hospital secure network are coupled with external communications mechanisms which can acquire or store NDMA content. The connecting device maintains the integrity of the hospital network security and incorporates its own strong firewall-like protections.

To maintain security within the hospital private network, all administrative functions and connections to the communication devices are secured. This is accomplished with a secure, protected web interface (port). The interfaces support the use of strong authentication via smart cards and embedded security certificates, thus providing authentication of the individual performing the operation as well as the location or machine where the operation was performed. Thus, it is possible to allow only authorized data to be transmitted and/or received to/by the WallPlug via the secure web port. Also, the communication of medical records via external networks is encrypted to protect patient privacy. The WallPlug supports VPN encryption or any other encryption required for a secure external network. Any appropriate encryption/decryption techniques can be utilized such as symmetric key and/or public key cryptographic techniques for example.

To eliminate the need of onsite (hospital or clinic) maintenance or staffing, the communication devices can be externally managed and controlled. The WallPlug operates without any operational support requirements from hospital/clinic staff and can be securely controlled and monitored from an external location. Further, the communicating devices have a high degree of redundancy, are able to be self monitored and tested, and are able to operate temporarily in the event of communication failures.

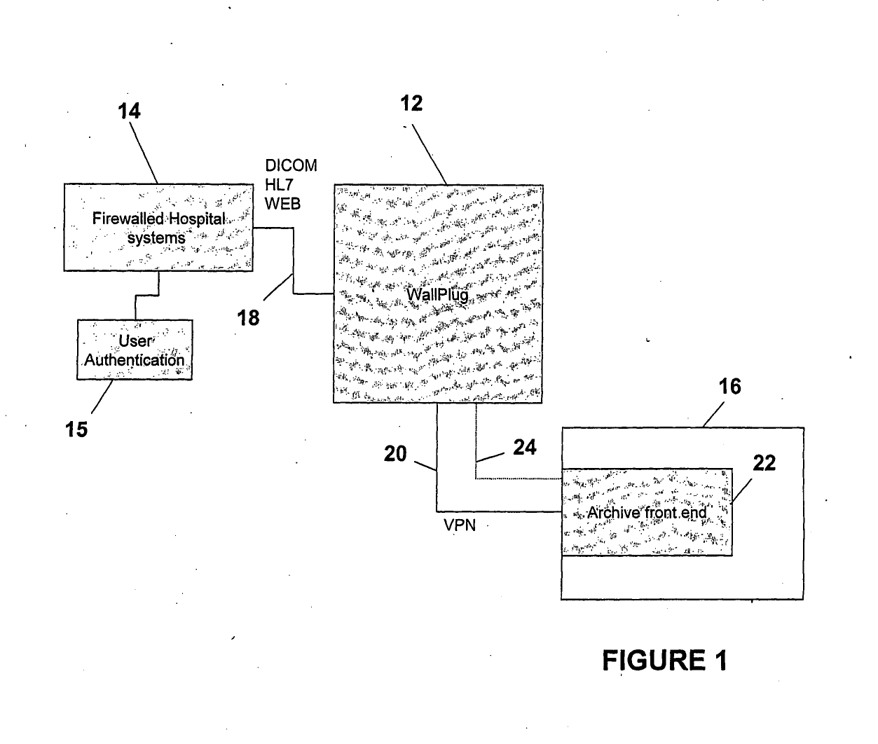

FIG. 1 is a simplified block diagram of WallPlug 12 coupled to firewalled hospital systems 14 and coupled to an archive front end 22 of an archival and retrieval system 16 in accordance with an exemplary embodiment of the present invention. The WallPlug 12 is coupled to the firewalled hospital systems 14 via a TCPIP compatible network 18. The WallPlug 12 is coupled to the archive front end 22 via a virtual private network (VPN) 20. The network 18 can be any appropriate TCPIP compatible network such as a DICOM compatible network, an HL7 compatible network, an Internet or Web compatible network, or the like. The VPN compatible network 20 can be any appropriate VPN. In one embodiment, the VPN 20 is an encrypted VPN. In another embodiment, the VPN 20 can be supplemented by a second VPN 24 for redundancy or independent monitoring.

The network 18 provides virtual secured access, such as DICOM, HL7, and/or web access, from enabled hospital/clinic medical devices, smart cards, or certificate enabled systems via user authenticator 15 through the combination of servers in the WallPlug 12. The WallPlug 12 provides secured access to test records, patient records, administrative control, or a combination thereof. The WallPlug 12 presents a secure web user interface and a DICOM hospital instrument interface on the hospital side and a secure connection to the archive on the VPN side. The WallPlug 12 makes no assumptions about external connectivity of the connected hospital systems 14 and can operate without any connectivity other than the VPN 20. In one embodiment, the WallPlug 12 comprises an external connection to a second VPN 24 for providing communications redundancy, hardware testing, and/or management in the event of a failure.

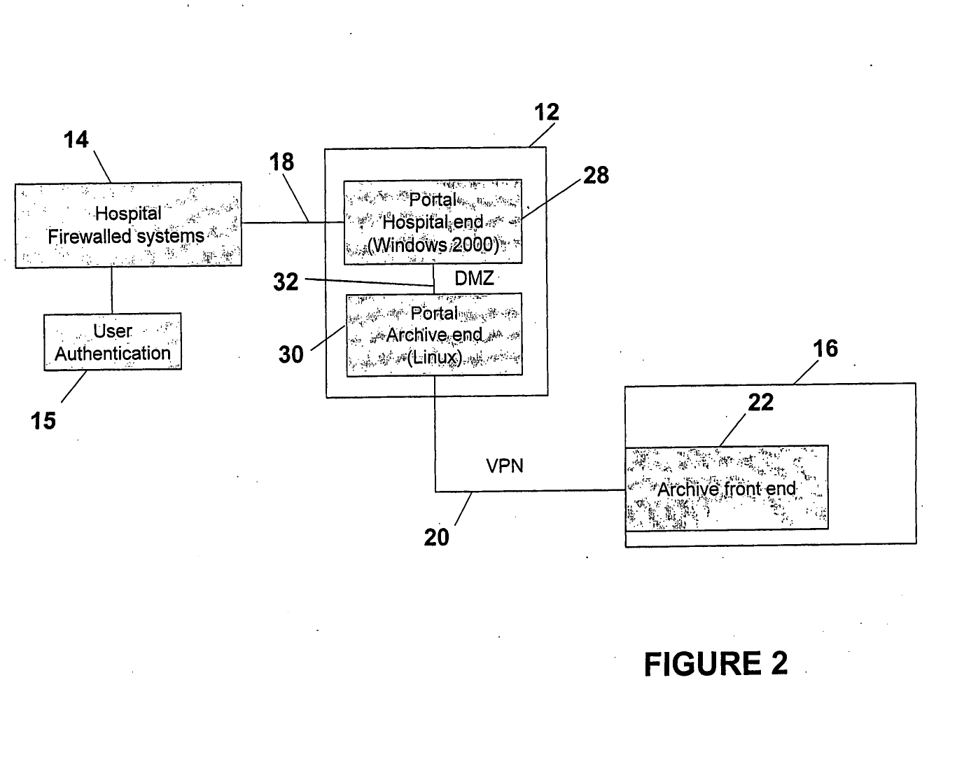

FIG. 2 is a simplified block diagram of the WallPlug 12 comprising a first portal system (portal) 28 coupled to the DICOM compatible network 14 and a second portal 30 coupled to the virtual private network 20 in accordance with an exemplary embodiment of the present invention. The two portals 28, 30 are coupled together via a private secure network 32. The WallPlug 12 provides the on-site hospital/clinic medical interface to external services and systems. Generally, the WallPlug 12 can be constructed from any pair of servers or special hardware with two isolated processor units. In an exemplary configuration, each portal may comprise an IBM server, each portal having two CPUs, two redundant power supplies, and a management interface. The two management interfaces can be linked together to an ASM (system management device) which can be used to externally monitor the two systems. The portals 28, 30 do not necessarily need to operate under the same operating systems. For example, the exemplary depiction shown in FIG. 2 shows the portal 28 operating under WINDOWS° 2000 and the portal 30 operating under LINUX®. It is to be understood that the portals 28, 30 can operate under other combinations of operating systems (including the same operating system), and should not be limit to the exemplary operating systems depicted in FIG. 2. The portals 28, 30 are the sole hardware interface between the hospitals systems 14 and the distributed storage and retrieval services systems 16. The portals 28, 30 are easily deployed and maintained, and provide secure encrypted links between the hospital systems 14 and the archive systems 16.

The WallPlug 12 comprising the portals 28, 30 provides low development and maintenance costs, redundancy of equipment, remote management, and remote diagnostic capabilities. To address the heightened reliability and security concerns associated with medical information, the WallPlug 12 provides a small footprint of archive-controlled and archive-trusted hardware at the hospital site. Further, the WallPlug 12, functioning as a bridge between the internal hospital systems 14 and the external archive systems 16, provides the ability to restrict transmissions and control access into and out of the portals 28, 30. The ability to restrict transmissions and access helps to relieve any concerns that hospital personnel, such as security personnel, may have pertaining to a compromise or threat to the hospital systems. The WallPlug 12 comprises an integrated, preconfigured set of hardware and software to provide isolation and access control. This level of isolation and control provided by the WallPlug 12 comprising portals 28, 30 cannot be provided on miscellaneous systems already resident in a hospital, nor can this level of isolation and control be provided by a software-only solution.

Because the WallPlug 12 forms a bridge between internal hospital networks (typically firewalled) and outside networks, the portals are deployed (physically located) at a location that has access to both the hospital side network 18 and the external side network 20. It is envisioned that this location will be the network or telecommunications center of the hospital or clinic, where the external connections and firewalls are managed. This provides a suitable preexisting location where the portals can be kept in the required locked and controlled-access location. The WallPlug 12 is self-contained and pre-connected, and in one embodiment comprises a single network connection to the hospital network 18 and two connections to the external networks 20, 24. Hospital networking staff can simply provide two static external and one static internal IP address prior to installation for the configuration of the WallPlug. In this way, the portal systems can be deployed at a very large number of locations with minimal impact on hospital IT staff. In another embodiment, the WallPlug 12 functions behind a hospital firewall.

The WallPlug 12 is part of the archive and not part of the local hospital infrastructure. The WallPlug 12 represents the local footprint for archive services at the hospital location. The job of monitoring the hardware and software status of these WallPlugs can thus be envisioned as a responsibility of the Archive. It is desirable not to use personnel at the local hospital or clinic to manage the WallPlug system. Instead, the archive systems are programmed to manage and monitor multiple WallPlugs 12. This eliminates hiring and training requirements for hospitals and eliminates operations that could compromise either the security or the operational stability of the portals. The latter can be implemented in a scalable fashion requiring little intervention at the hospital site.

Referring again to FIG. 2, the hardware components of the WallPlug 12 comprise two portals 28, 30 linked together by a private secure network 32. In an exemplary embodiment, the private secure network 32 comprises a single crossover cable on which all protocols and transmissions can be controlled and to which no access is provided (other than via those protocols) from outside the WallPlug 12. Each end of the crossover cable link 32 is secured to allow only NDMA approved transactions, protocols, and ports. Each portal 28, 30 has at least two network devices. That is, the portal 28 has a network device coupled to the networks 32 and 18, and the portal 30 has network devices coupled to the networks 32 and 20 (and optionally 24).

In an exemplary configuration, the two portals 28, 30 are connected together with a short crossover cable (network) which can be physically secured or monitored for intrusion. In this exemplary configuration the address space on that network is a private 10.0.0.0/8 network. A 10.0.0.0/8 network is a private address space as defined by TCPIP standards [RFC 1918] and in this case is implemented with an isolated and non-routed network interface. Non-routed means that network communications on this network are not communicated to any other network interfaces or addresses. This forms the private link 32 between the portals 28, 30. The remaining two network connections are the hospital and external connections. One portal 28 is connected to the hospital side and the other portal 30 is connected to the archive side. In this exemplary configuration, on the hospital side, a standard network interface card [NIC] is used, and on the archive side, a 3COM 3CR990 NIC card is used which implements a hardware encrypted VPN at up to 100 Mbit/s or software encryption on a standard NIC. In this exemplary configuration, the hospital side portal runs, e.g., WIDOWS® 2000, and the Archive side runs, e.g., RED HAT LINUX®. The kernels are modified to support hardware and software encryption. The two portals are referred to as the WPortal (e.g., portal 28) and LPortal (e.g., portal 30), respectively. The crossover cable 32 linking the two portals provides a security DMZ and no protocols are allowed to cross between the portals except for a very restricted subset. This isolation of components is referred to as a DMZ (demilitarized zone), in which no network traffic is allowed in or out of the network without inspection. As additional security precautions, only private protocols are allowed on the crossover connection 32, the portals utilize no domain name resolution [DNS] or external name service, and provide IPSEC (Internet Protocol Security) filtering on the WINDOWS side and TCP wrappers on the LINUX side, and the portals 28, 30 also provide their own isolated Certification Authority services.

As described above, in one embodiment, the archive system can be an NDMA. In this embodiment, the NDMA system utilizes two primary services on the hospital side: DICOM, HL7 and other hospital device interface functions and secondly, secured user interface functions. All other services are blocked. DICOM services make the archive took like a virtual instrument inside the hospital with the exception that the DICOM services are only accessible from pre-approved devices with the correct characteristics (e.g., IP addresses, DICOM Application entities and port numbers). The DICOM server supports CSTORE for inbound connections from digital medical devices and read stations, and supports CMOVE and CSTORE for the transfer of records back to approved locations. The server supports CFIND for Modality Worklist queries and CFIND Query/Retrieve for access to a local cache of recently used records. All other DICOM functionality is blocked.

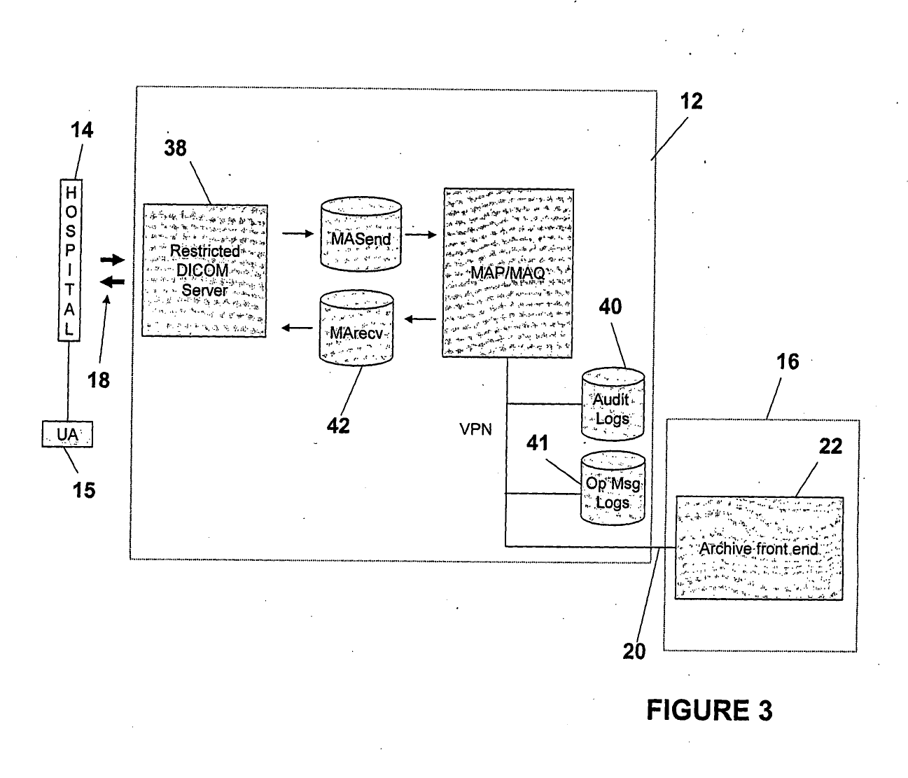

FIG. 3 is an overall functional view of software components utilized to transfer data between the hospital systems 14 and the archive 16 in accordance with an exemplary embodiment of the present invention. This overall functional view illustrates the functionality of the WallPlug 12 and does not show the hardware separation between the two portals 28, 30 by connection 32. As shown in FIG. 3, the portal software on the hospital side is responsible for running the DICOM server 38, and for transferring files from the DICOM server 38 to the archive end of the portal 30. The software that does this is called MAP. This software comprises DICOM test and diagnostic software, a queue manager that watches for new files in the input MASend directory 39, and mechanisms to transfer the files via sockets on the crossover cable 32 to the backend. All activities which move or manipulate files are logged in two databases, one for operational messages 41 and one which audits, the movement of all files 40. The latter is required for HIPAA (Health Insurance Portability and Accountability Act) compliance and both are forwarded to the archive periodically and entered into a master database. The queue software detects errors and will retry the transmission to the next stage as necessary. Sufficient local cache can be implemented on the system to allow autonomous operation for days should downstream elements be temporarily inoperable.

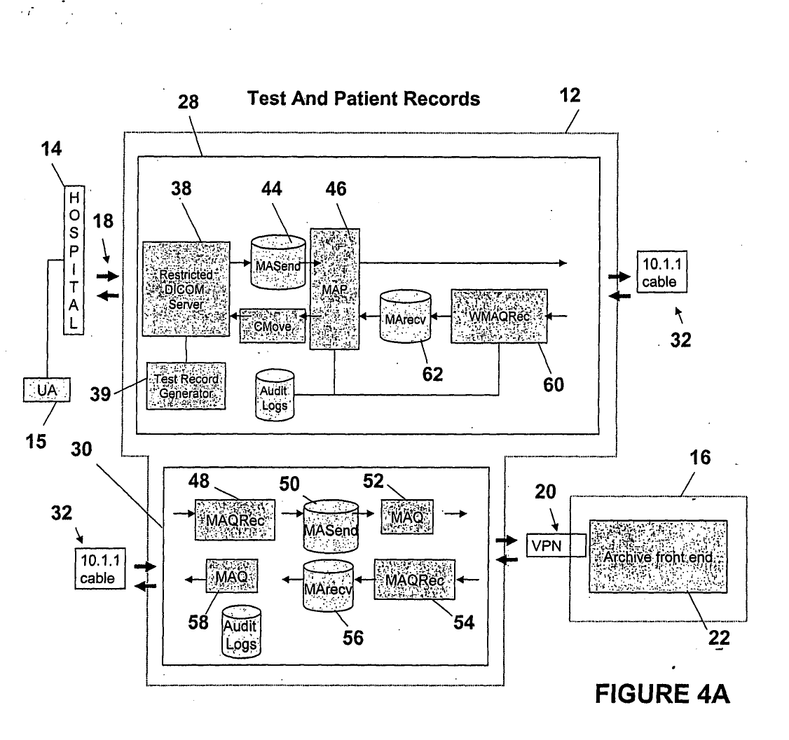

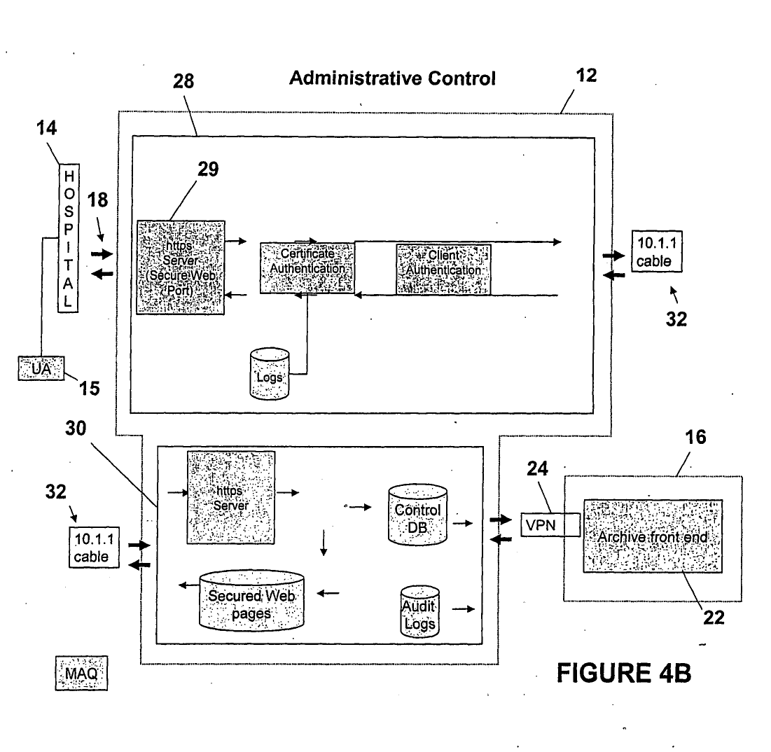

FIG. 4A is a more detailed block diagram of the WallPlug 12 showing software and hardware components utilized for test records and patient records in accordance with an exemplary embodiment of the present invention. FIG. 4A shows the data flow between the hospital 14 and the archive 16 and return. It is implemented by using generalized senders and receivers along with MAP 46, which is the primary traffic manager, logger and scheduler. MAQ 52 is a sender that takes files from a worklist and sends them to a receiver. MAQRec 54, on the other hand, is a receiver that receives files and places them in a queue. Both processes log all actions in, e.g., audit logs 45. In an exemplary embodiment of the WallPlug 12 in accordance with the present invention, test record generator 39 generates test data for verifying the performance of the WallPlug 12. Test records are actual data except that they contain a special security certificate. To all processes between the test generator and the archive 16, these items are indistinguishable from real data. Based on their certificate, they can be purged later from the archive file spaces and indices. These test records therefore can be used to verify the proper function of all components of the systems even in the absence of real data arriving from hospital systems through network 18. This capability allows the WallPlug 12 to generate “heartbeats” which can be checked and verified at the archive 16, or to generate and/or transmit specific test records to verify compatibility of those records with the system for vendor qualification. The rate at which test records are generated can be controlled and use to test the throughput and other performance characteristics of the WallPlug 12 itself or the archive systems 16, or the connecting networks and protocols.

The portal software of portal 30 also assists in the transfer of records back to the hospital 14. Files received from the archive 16 are logged and verified and then transferred via a socket protocol (e.g., WMAQRec) running on the private cable 32 which receives files from the backend and stores them in the MARecv directory 62. The MAP software receiver components 46 transfer and log these files to approved locations using a CMOVE through the DICOM server 38. Again, all movement of files is logged and the logs are forwarded to the archive 16 periodically.

FIG. 4B is a more detailed block diagram of the WallPlug 12 showing software and hardware components utilized for administrative functions and authentication in accordance with an exemplary embodiment of the present invention. In an exemplary embodiment, hospital side administrative functions including smart card registration, user registration and password management, DICOM device registration and configuration, records status queries, and user initiated requests for records are implemented. These user interface components are provided by exposing an Apache https port of an https server 29. Apache is an Open Standards web server and https provides secure and encrypted web site access. The web site derives its pages and parameters from the backend Linux box (portal 30) and is implemented with server and client authentication certificates. Communications between the two servers are implemented with Apache-jakarta-tomcat, an open standards mechanism for redirection of server pages to another server. This configuration provides secured access to hospital workstations with either smart card authentication devices and properly signed smart cards or embedded security certificates. By keeping the web functions isolated in this fashion, security is maintained even if security on one of the two portals 28, 30 is temporarily breeched. Use of two dissimilar operating systems on the two portals of the WallPlug 12 (e.g., WINDOWS® and LINUX®) also eliminates exposure to security flaws in a single operating system (OS). If the same OS were used on both portals, a common flaw could make it easier to compromise the system security. In an exemplary embodiment of the WallPlug, access to the https server 29 is controllable within the hospital by smart card access and/or embedded certificates via user authenticator 15. Thus, the WallPlug provides the required combination of services while at the same time blocking access and providing adequate security, simultaneously isolating the hospital from the archive and the archive from the hospital.

The hardware and software components of the WallPlug 12 require minimal customization other than internal and external IP addresses in order to make it easier to replicate them and to deploy.

Transfer from Hospital to Archive

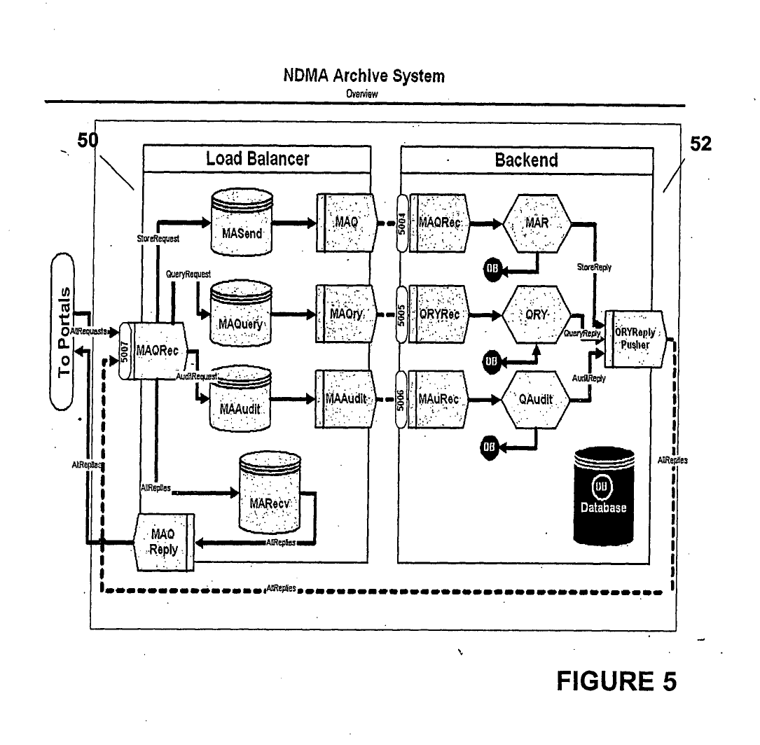

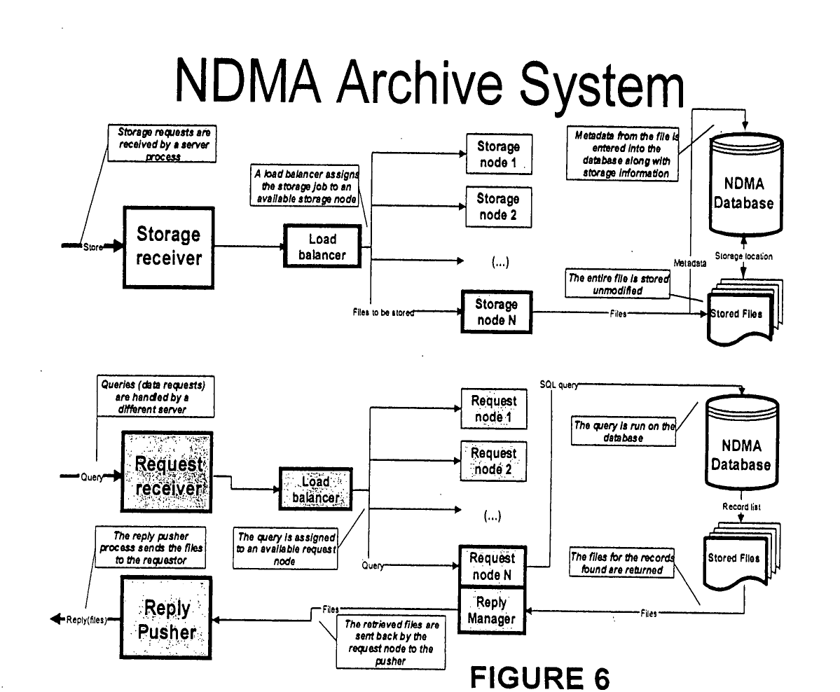

FIGS. 5 and 6 are presented to provide a better understanding of the transfer of data between the hospital/clinic 14 and the archive 16. FIG. 5 is a block diagram of software components in the load balancer 50 and backend section 52 of the NDMA utilized to transfer data to and from the NDMA, in accordance with an exemplary embodiment of the present invention. FIG. 6 is a basic functional block diagram of the NDMA system utilized in accordance with an exemplary embodiment of the present invention. For a better understanding of FIGS. 5 and 6 herein, please refer to the related application entitled, “NDMA SCALABLE ARCHIVE HARDWARE/SOFTWARE ARCHITECTURE FOR LOAD BALANCING, INDEPENDENT PROCESSING, AND QUERYING OF RECORDS”, Attorney Docket UPN-4382/P3189, filed on even date herewith, the disclosure of which is hereby incorporated by reference in its entirety.

Referring again to FIG. 4A, and noting that as described above, in one embodiment the archival system 16 comprises the NDMA system, while the portal 28, operating under the WINDOWS® 2000 operating system, is referred to as the WPortal; and the portal 30, operating under the LINUX® operating system, is referred to as the LPortal. Traffic (data) from the hospital 14 flows from a device in the hospital/clinic to the DICOM server 38 in the WPortal 28. Data is stored in a queue called MASend 44. From there it is transferred to a worklist by MAP 46 and the DICOM content is verified. MAP 46 prepares an XML wrapper and sends it to the LPortal 30 via a socket protocol on the 10.1.1. cable 32. In the LPortal 30, there are two implementations of transfers which use separate port numbers. The first is used for heartbeat and test traffic and also supports patient transfers; the second is used solely for patient record traffic. The receiver for heartbeat and test traffic is MAQRec 48 and all received files are logged and placed in the MASend queue 50. Another MAQ sender 52 transfers these files over the VPN 20 (or alternatively 24) to the archive 16. The second transport chain supports patient records transfer and requests. The software ensures that all transferred items are successfully transmitted to disk and are persistent (i.e. will survive power failures, restarts, etc.) before moving to the next item. The software automatically logs and recovers from failures. The matched sender and receiver queues can be on the same machine (for feeding different local processes), on different machines on a local network, or on different geographically dispersed and possible operating system heterogeneous machines. The use of XML wrappers provides timestamp, place of origin, and authentication information about the transfer. These XML fields are a virtual envelope and postmark for the transmission. When files are transferred, the contents of this virtual envelope are saved in the backend database (see FIG. 5) for NDMA. The envelope itself is also saved in order to facilitate reconstruction of an archive or movement of portions of an archive to a replication site.

Transfer from Archive to Hospital

In the reverse direction (i.e., data flow from the archive 16 to the hospital 14), files from the archive 16 are sent over the VPN 20 and received by an MAQRec process 54 which stores them in an MARecv queue 56. Another MAQ process 58 transfers these files over a socket on the private 10.1.1. cable 32 to the receiver process on the WPortal which is WMAQRec 60. WMAQReC 60 extracts destination information from the XML wrappers of the files and stores them in MARecv 62 with the destination address, DICOM port and DICOM Application Entity Title [AET] in the filename. Files from MARecv 62 are logged and transferred by MAP 46 to the DICOM server 38 using a CMOVE for subsequent transfer to the intended hospital destination.

Heartbeat and Software Monitors

The MAP software can be used to insert test records at the front end of the system which then traverse the entire system including insertion into the archive. The test records differ from the real data only in that they carry a hash of a certificate that indicates they are test data. These records provide a constant heartbeat test of the operation of the systems and the connections between the hospital and the archive. This traffic can be used in several other ways.

First, it can be used for performance testing of the backend archive systems, and second it can be used to monitor the health of the front end systems. Portals that do not submit records to the archive with the expected frequency to the archive can trigger monitor and diagnostic procedures there. Also, since records submitted to the archive are followed by a response returned to the portal, the timing between these events as seen on the portal can provides information to the portal about conditions in the archive and on the connecting networks.

The WallPlug 12 has autonomic components to recover automatically from some situations. Loss of the LPortal system cuts off the portal 30 from the archive 16 and is automatically recovered if possible. Also, to avoid manual intervention in the case of a loss of connectivity to the LPortal box 30 from the archive 16, the WallPlug. 12 implements a second maintenance interface on a second external connection and this can be used to reconnect the LPortal 30 and/or diagnose it. The WPortal 28 will continue to function and accumulate requests from the hospital while connectivity is tested and until it is reestablished thus preserving the hospital/clinic's ability to function. One example of self-recovery occurs in cases of network problems with the VPN 20, which can occasionally be down. The LPortal 30 monitors (pings) the connectivity to the WPortal 28 and to the archive 16 through the VPN tunnel. Loss of connectivity on the tunnel end causes a restart of the tunnel kernel module, and loss of connectivity on the WPortal end 28 causes an error report to be forwarded to the archive 16. The WPortal box 28 is operated though a Virtual Network Computing [VNC] connection on the private cable 32. VNC is an open systems interface to Windows screens originally developed by AT&T.

As described herein, a WallPlug 12 in accordance with the present invention overcomes Internet limitations of not being able to handle transport protocols defined in DICOM in a manner consistent with security considerations. The WallPlug 12 supports DICOM record formats and DICOM transactions and supports NDMA socket protocols for all external transport of records. The WallPlug 12 enables the cross-enterprise exchange of medical records and connects internal hospital networks to external services and networks using isolated communication links to the internal hospital network and to external networks. Further, the WallPlug is DICOM, HL7, and IHE compliant on the hospital side and can thus communicate with any approved DICOM compliant devices on the hospital network. This includes medical instruments for a broad range of modalities (mammography, CT, MRI, etc.), PACS systems, and RIS systems. IHE stand for “Integrating the Healthcare Enterprise”; an evolving standard for workflow and integration of DICOM and HL7 applications. Optionally, the WallPlug 12 can incorporate lossless compression to reduce bandwidth requirements and provide capabilities for acquiring and providing Grid connections and services.

The WallPlug 12 further protects the security of the hospital network and protects the security of the links to the external networks. The WallPlug 12 incorporates encryption of external networks to satisfy patient privacy regulations and incorporates authentication certificates for client and user authentication to prevent its use from unauthorized locations or by unauthorized individuals. The WallPlug 12 manages security authentication of users and clients even when external networks are unavailable using embedded Certificate Authorities. The WallPlug 12 supports secure connections from within the hospital through the use of smart cards and certificates and a secure web interface to the device. A secure web interface enables administration of users, user certificates, authorized hospital devices, and verification or authorization of record transfer operations. Further, the WallPlug 12 can utilize two dissimilar operating systems to enhance security.

The WallPlug 12 enables connections from the hospital to large-scale storage and/or large-scale processing services that no longer need to reside at the hospital. The WallPlug 12 is also a virtual medical instrument within the hospital network. The services can be provided to hospitals regardless of internal choice of instrument or hospital services vendor. The WallPlug 12 can be managed externally and not require hospital staff management. The WallPlug 12 is highly redundant and supports remote diagnostics. The administrative functions accessible on the hospital side are held on the external side to prevent tampering. Secure web pages are served from the network side of the WallPlug 12 preventing unauthorized access or modification from internal hospital/clinic sites. The WallPlug 12 logs information about the identity of individuals or the certificates of machines that initiate patient record operations. The WallPlug 12 only allows access to the archive from preapproved devices with correct security certificates. The hospital side server cannot talk directly to the archive but must go through the external network side of the WallPlug 12. The WallPlug 12 can manufacture test records and forward them automatically to backend systems as a continuous “heartbeat” check of operational readiness. The WallPlug 12 can continue to function in the event of loss of external connectivity for a period of time (configurable) until connectivity can be reestablished.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed is:

1. An interface for coupling a first network with a second network, said interface comprising:
a first portal couplable to and compatible with said first network, wherein said first network is one of a digital imaging and communications in medicine (DICOM) compatible network and a hospital level 7 (HL7) compatible network;
a second portal couplable to and compatible with said second network, wherein said second network is at least one of a virtual private network (VPN) and a secure network and said second network includes at least one storage device; and
a private secure network for coupling said first portal to said second portal.

2. An interface in accordance with claim 1, wherein said private secure network comprises a non-routed crossover cable compliant with a 10.0.0.0/8 network standard.

3. An interface in accordance with claim 1, wherein said interface supports VPN encryption.

4. An interface in accordance with claim 1, wherein said first portal comprises a first operating system and said second portal comprises a second operating system different than said first operating system.

5. A system in accordance with claim 4, wherein said first portal comprises a WINDOWS 2000 operating system and said second portal comprises a LINUX operating system.

6. An interface in accordance with claim 1, wherein only selected data is transferable between said first and second portals via said private secure network.

7. An interface in accordance with claim 6, wherein said selected data is selectable via said first network.

8. An interface in accordance with claim 1, wherein said first network comprises an access controllable secure web port, said first portal is capable of receiving and transmitting only authorized data via said first network, and said authorized data comprises data conveyed via said access controllable secure web port.

9. An interface in accordance with claim 8, wherein access to said secure web port is controllable via at least one of a smartcard and an embedded certificate.

10. An interface in accordance with claim 1, wherein said first portal provides IPSEC filtering of data conveyed therein and said second portal provides a TCP wrapper to data conveyed therein.

11. An interface in accordance with claim 1, wherein said first portal is capable of receiving and transmitting only data pertaining to DICOM related functions and user related functions.

12. An interface in accordance with claim 11, wherein said DICOM related functions comprise at least one of receiving data records from said second portal and providing data records to said second portal.

13. An interface in accordance with claim 1, wherein said first portal performs at least one of:
controlling a DICOM server;
DICOM test and diagnostic functions;
managing a queue of files; and
transferring data to and receiving data from said second portal.

14. An interface in accordance with claim 1, wherein said at least one storage device comprises a plurality of archive devices.

15. An interface in accordance with claim 1, wherein said at least one storage device comprises at least one national digital mammography archive (NDMA).

16. A method for transferring data between a digital imaging and communications in medicine (DICOM) compatible device and a storage device, said method comprising:
receiving DICOM related data;
storing said received DICOM related data in a data queue managed by a DICOM server;
transferring said data queue to a work list;
verfying said DICOM related data;
formatting said DICOM related data into a format compatible with said storage device; and
transmitting said DICOM related data via a virtual private network (VPN) to said storage device.

17. A method in accordance with claim 16, wherein the transmitting step includes transmitting the DICOM related data to one of an archive and a national digital mammography archive.

18. A method in accordance with claim 16, wherein said DICOM related data is formatted in accordance with extensible markup language (XML) wrapper and transmitted via a socket protocol.

19. A method in accordance with claim 16, wherein the transmitting step includes the steps of:
providing the DICOM related data to a first portal coupled to said DICOM compatible device;
transferring the DICOM related data from the first portal over a private secure network to a second portal; and
transferring the DICOM related data from the second portal to said storage device.

20. A method in accordance with claim 16, further comprising the step of embedding records within said DICOM related data for accessing performance.

21. A system for transferring data between a medical device and a storage device via an interface, wherein:
said medical device comprises at least one of a digital imaging and communications in medicine (DICOM) compatible device and a hospital level 7 (HL7) compatible device;
said storage device comprises at least one of an archive and a national digital mammography archive (NDMA); and
said interface comprises:
a first portal couplable to and compatible with said medical device;
a second portal couplable to and compatible with said storage device; and
a private secure network for coupling said first portal to said second portal.

22. A system in accordance with claim 21, wherein said private secure network comprises a non-routed crossover cable compliant with a 10.0.0.0/8 network standard.

23. A system in accordance with claim 21, further comprising at least one of encryption hardware and encryption software for encrypting data provided by said second portal.

24. A system in accordance with claim 21, wherein said first portal comprises a first operating system and said second portal comprises a second operating system different than said first operating system.

25. A system in accordance with claim 21, wherein said first portal comprises a WINDOWS 2000 operating system and said second portal comprises a LINUX operating system.

26. A system in accordance with claim 21, wherein only selected data is transferable between said first and second portals.

27. A system in accordance with claim 26, wherein said selected data is selectable via a network coupled to said medical device.

28. A system in accordance with claim 21, wherein a network comprising said medical device comprises an access controllable secure web port;
said first portal is capable of receiving and transmitting only authorized data via said network comprising said medical device; and
said authorized data comprises data conveyed via said access controllable secure web port.

29. A system in accordance with claim 28, wherein access to said secure web port is controllable via at least one of a smartcard and an embedded certificate.

30. A system in accordance with claim 21, wherein said first portal provides IPSEC filtering of data conveyed therein and said second portal provides a TCP wrapper to data conveyed therein.

31. A system in accordance with claim 21, wherein said first portal is capable of receiving and transmitting only data pertaining to DICOM related functions and user related functions.

32. A system in accordance with claim 31, wherein said DICOM related functions comprise at least one of receiving data records from said second portal and providing data records to said second portal.
